(19) United States
(12) Patent Application Publication
(10) Pub. No.: US 2003/0148885 A1
(43) Pub. Date: Aug. 7, 2003

(54) Shaped body containing organic-inoraganic hybrid materials, the production thereof and the use of the same selectively oxidizing hydrocarbons

(76) Inventors: Markus Weisbeck, Koln (DE); Gerhard Wegener, Leverkusen (DE); Wolfgang Arlt, Wermelskirchen (DE); Lothar Puppe, Burscheid (DE)

Correspondence Address: BAYER POLYMERS LLC, 100 BAYER ROAD, PITTSBURGH, PA, 15205, US

(21) Appl. No.: 10/276,346

(22) PCT Filed: May 4, 2001
(86) PCT No.: PCT/EP01/05072

(30) Foreign Application Priority Data
May 17, 2000 (DE) 100237177

(51) Int. Cl. B01J 20/02

(52) U.S. Cl. 502/400; 502/407; 502/405; 423/652; 264/623

(57) ABSTRACT

The invention relates to shaped bodies containing organic-inorganic hybrid material in addition to gold and/or silver particles, to a method for the production thereof and to the use of the same as catalysts. The shaped-body catalysts are characterized by a longer service life than the original powder catalysts, in addition to a high selectivity and productivity. The inventive shaped-body catalysts also enable pressure losses to be kept to a negligible level in technically sophisticated reactors, for example fixed-bed reactors.

The present invention relates to moulded bodies containing organic/inorganic hybrid material and also gold and/or silver particles, to a process for the production thereof, and to the use thereof as a catalyst. The moulded-body catalysts exhibit longer useful lives than the original powder catalysts, while having a high degree of selectivity and high productivity. The moulded-body catalysts according to the invention also make it possible to achieve very low pressure losses in technically relevant reactors such as, for example, fixed-bed reactors.

Powder catalysts containing gold and titanium are known inter alia from patent specifications U.S. Pat. No. 5,623,090, WO-98/00415-A1, WO-98/00414-A1, EP-A1-0 827 779, DE-A1-199 18 431 and WO-99/43431-A1. Organic/inorganic hybrid materials are not disclosed, however.

Powder catalysts containing organic/inorganic hybrid materials are known from the older applications DE-19 959 525 and DE-19 920 753. However, moulded bodies are not disclosed.

All the processes published hitherto have the disadvantage that the disclosed catalysts become inactive with time.

Purely inorganic powder catalysts generally exhibit typical half-lives of from 0.5 to a maximum of 10-50 hours at normal pressure. Raising the temperature and/or pressure in order to increase the conversion shortens the half-lives further. Accordingly, none of those powder catalysts, which are obtained by impregnation of the purely inorganic silicate surface with titanium precursors in solution and subsequent coating with gold by deposition-precipitation and subsequent calcination in an atmosphere of air, can be used in large-scale installations.

The activity and the useful life of a catalyst are increased substantially by the use of gold- and titanium-containing organic/inorganic hybrid support materials, as described in the older applications DE-199 59 525 and DE-199 20 753. In alkene oxidation processes, catalysts based on organic/inorganic hybrid materials exhibit typical half-lives of from 500 to 2000 hours at normal pressure. Raising the temperature and pressure in order to increase the conversion shortens the half-lives only slightly. Nevertheless, such powder catalysts can be used in large-scale processes only with difficulty since they exhibit extremely high pressure losses, pronounced channelling and hot-spots in industrial processes using a fixed bed.

For industrial processes it is desirable to develop catalysts that achieve industrially valuable useful lives while having excellent selectivity and high productivity. As low a pressure loss as possible over the bulk of the catalyst is also desirable.

It was an object of the present invention to provide novel moulded-body catalysts having low pressure losses for industrial processes, the selectivity and productivity of which catalysts are analogous to those of the original powder catalysts.

A further object was to develop a process for the production of such highly active moulded-body catalysts.

A further object was to make available a technologically simple gas-phase process for the selective oxidation of hydrocarbons using a gaseous oxidising agent on such moulded-body catalysts, which process results in high yields and low costs with high catalyst productivity, very high degrees of selectivity and technically valuable useful lives of the catalysts.

A further object was to provide an alternative moulded-body catalyst for the direct oxidation of hydrocarbons.

A further object was to eliminate at least some of the disadvantages of the known powder catalysts.

The objects are achieved by moulded bodies containing organic/inorganic hybrid materials and also gold and/or silver particles.

Organic/inorganic hybrid materials within the scope of the invention are organically modified glasses which are preferably formed in sol-gel processes via hydrolysis and condensation reactions of mostly low molecular weight compounds and which contain terminal and/or bridging organic groups and, advantageously, free silane units in the network and are described in DE-19 959 525 and DE-19 920 753, which for US-American practice are herewith incorporated in the application by reference.

Preference is given to organic/inorganic hybrid material containing titanium and silicon and optionally having a content of free silane units.

The moulded bodies contain nano-scale gold and/or silver particles on an organic/inorganic hybrid material. In the catalytically active state, gold and/or silver is frequently present in the form of the elemental metal (analysis by X-ray absorption spectroscopy). Small gold and/or silver contents may also be present in a higher oxidation state, such as in noble metal ions or charged clusters. Judging by TEM images, the majority of the gold and/or silver present is at the surface of the organic/inorganic hybrid material. It is neutral and/or charged gold and/or silver clusters on the nanometer scale. The gold particles preferably have a diameter in the range from 0.3 to 20 nm, preferably from 0.9 to 10 nm and particularly preferably from 1.0 to 9 nm. The silver particles preferably have a diameter in the range from 0.5 to 100 nm, preferably from 0.5 to 40 nm and particularly preferably from 0.5 to 20 nm.

The concentration of gold in the powder catalyst (which is later converted into moulded bodies) is to be in the range from 0.001 to 4 wt. %, preferably from 0.005 to 2 wt. % and particularly preferably from 0.009 to 1.0 wt. % gold.

The concentration of silver is to be in the range from 0.005 to 20 wt. %, preferably from 0.01 to 15 wt. % and particularly preferably from 0.1 to 10 wt. % silver.

For reasons of economy, the content of noble metal should be the minimum amount necessary to achieve maximum catalytic activity.

Production of the noble metal particles on the organic/inorganic hybrid material is not limited to one method. Some examples of methods of generating gold and/or silver particles are mentioned here, such as deposition-precipitation, as described on page 3, line 38 ff of EP-B-0 709 360, impregnation in solution, incipient wetness, colloid processes, sputtering, CVD, PVD. It is also possible to integrate precursor compounds of the noble metals or colloids directly into a sol-gel process. After drying and tempering of the noble-metal-containing gels, nano-scale gold and/or silver particles are likewise obtained.

Incipient wetness is to be understood as meaning the addition of a solution containing soluble gold and/or silver compounds to the oxide-containing support material, the volume of solution on the support being less than, equal to or slightly greater than the pore volume of the support. The support thus remains macroscopically largely dry. Solvents which may be used for incipient wetness are all solvents in which the noble metal precursors are soluble, such as water, alcohols, ethers, esters, ketones, halogenated hydrocarbons, etc.

Nano-scale gold and/or silver particles are preferably produced by the methods of incipient wetness and impregnation.

Before and/or after being coated with the noble metal, the powdered organic/inorganic hybrid material can be further activated by heat treatment in the range from 100 to 1200° C. in various atmospheres and/or gas streams, such as air, oxygen, nitrogen, hydrogen, carbon monoxide, carbon dioxide.

In a preferred embodiment, heat activation takes place at from 120 to 600° C. in air or in oxygen-containing gases, such as oxygen, or oxygen/hydrogen or oxygen/noble gas mixtures or combinations thereof.

However, heat activation is preferably carried out in the range from 120 to 1200° C. under inert gas atmospheres or streams, such as nitrogen and/or hydrogen and/or noble gases and/or methane or combinations thereof.

Activation of the noble-metal-containing compositions obtained in the process according to the invention under inert gases in the range from 150 to 600° C. is particularly preferred.

It may, however, also be advantageous to subject the noble-metal-free support materials to heat treatment at temperatures in the range from 200 to 1200° C., then coat them with noble metal and subsequently subject them to heat treatment again at from 150 to 600° C. Depending on the chosen activation temperature, chemical processes change the structure of the compositions according to the invention. Thus, for example, the organic/inorganic hybrid compositions may contain silicon oxycarbide units after heat treatment. The heat-activated compositions frequently exhibit a significantly higher catalytic activity and a longer useful life in comparison with known catalysts.

The catalytically active noble-metal-containing organic/inorganic hybrid materials, which are subsequently processed to moulded bodies, contain, based on silicon dioxide as the base component, from 0.1 to 20 mol % titanium, preferably from 0.5 to 10 mol %, particularly preferably from 0.8 to 7 mol %. The titanium is in oxidic form and is incorporated or bonded in the silicon dioxide lattice preferably chemically via Si—O—Ti bonds. The titanium species is present principally in the form of the isolated Ti(IV) species. In some cases, it has also been possible to detect Ti³⁺ species; the Ti³⁺ species are presumably stabilised by the SiOₓ matrix. In active catalysts of this type, Ti—O—Ti domains are present only very subordinately.

Without wishing to be bound thereto, it is assumed that in active catalysts based on organic/inorganic hybrid materials, titanium is bonded to silicon via heterosiloxane bonds.

In addition to titanium, there may also be present further foreign oxides, so-called promoters, from group 5 of the periodic system according to IUPAC (1985), such as vanadium, niobium and tantalum, preferably tantalum and niobium, from group 6, preferably molybdenum and tungsten, from group 3, preferably yttrium, from group 4, preferably zirconium, from group 8, preferably iron, from group 9, preferably iridium, from group 12, preferably zinc, from group 15, preferably antimony, from group 13, preferably aluminium, boron, thallium, and metals of group 14, preferably germanium.

The majority of such promoters are advantageously present homogeneously, that is to say with relatively little domain formation. The incorporated promoters “M” are generally present in the organic/inorganic hybrid materials in disperse form. The chemical composition of such materials can be varied widely. The amount of promoter element, based on silicon dioxide, is in the range from 0 to 10 mol %, preferably from 0 to 3 mol %. Of course, it is also possible to use several different promoters. The promoters are preferably used in the form of promoter precursor compounds that are soluble in the solvent in question, such as promoter salts and/or promoter organic compounds and/or promoter organic/inorganic compounds.

Such promoters may increase both the catalytic activity of the organic/inorganic hybrid materials and the useful life of the organic/inorganic hybrid materials in catalytic oxidation reactions of hydrocarbons.

If such promoters are incorporated in or added to organic/inorganic hybrid materials that do not contain a species of titanium oxide, heat activation yields compositions that have no or markedly lower catalytic activity as compared with titanium-containing systems.

The titanium-containing organic/inorganic hybrid materials are usually prepared either by impregnating an organic/inorganic silicon dioxide matrix with a titanium oxide precursor compound or, preferably, by sol-gel processes. Sol-gel preparation is carried out, for example, by mixing suitable, usually low molecular weight compounds in a solvent, following which the hydrolysis and condensation reaction is initiated by the addition of water and, optionally, catalysts (e.g. acids, bases and/or organometal compounds and/or electrolytes). The carrying out of such sol-gel processes is known in principle to the person skilled in the art. Reference is made to L.C. Klein, Ann. Rev. Mar. Sci., 15 (1985) 227 and S. J. Teichner, G. A. Nicolaon, M. A. Vicarini and G. E. E. Garses, Adv. Colloid Interface Sci., 5 (1976) 245.

Surprisingly, it has been found that the useful life of the catalyst is prolonged markedly if the powdered catalytically active gold- and/or silver-containing organic/inorganic hybrid materials are converted into moulded bodies such as extrudates, granules, pellets, etc. After conversion of the compositions into moulded bodies, it was possible to reduce the tendency towards deactivation by a factor of from 2 to 3.

Although the adhesion of the active component to the support is important for a gas-phase process, the forces acting on the supported layer in a gas-phase process are less abrasive than, for example, in a liquid-phase process. The constant presence of liquid or solvent in particular can lead to destabilisation of the anchoring of the active substance on the inert support. Nevertheless, the moulded-body catalyst for a large-scale gas-phase process must possess good mechanical stability to maintain a low pressure loss, so that it can be introduced into the reactors, some of which are many metres high, without the risk of breaking.

Moulded bodies based on powdered catalytically active noble-metal-containing organic/inorganic hybrid materials for the selective oxidation of hydrocarbons in the presence of oxygen and a reducing agent have not yet been described.

With regard to the powdered catalytically active organic/inorganic hybrid materials that can be used to produce the moulded bodies according to the invention, no particular limitations exist as long as it is possible, starting from such materials, to produce a moulded body as described herein. The powdered catalytically active organic/inorganic hybrid materials disclosed in DE-19 959 525 and DE-19 920 753 are especially suitable.

The powdered catalytically active organic/inorganic hybrid materials may in principle be processed to moulded bodies by any known method, such as agglomeration by spray drying, fluidised-bed drying, spray granulation, extrudates, granules, tablets, etc.

In view of high mechanical strength, preference is given to extrudates and granules, especially when the powdered catalytically active noble-metal-containing organic/inorganic hybrid material is a hydrophobic material. Owing to the absence of polar crosslinking groups, such hydrophobic hybrid materials cannot be compressed to form tablets even in the presence of conventional additives such as graphite.

An advantageous process for the production of the moulded bodies according to the invention is characterised in that a metal oxide sol and/or metallic acid ester is added to gold- and/or silver-containing organic/inorganic hybrid material and, optionally after the addition of a binder, of a filler and optionally of an alkali and/or alkaline earth silicate, after mixing and compressing, the mixture is converted into moulded bodies using a shaping tool. The invention relates also to that process.

In general, the powdered catalytically active gold- and/or silver-containing organic/inorganic hybrid materials are made into a paste with one or more suitable binders, such as metal oxide sols or metallic acid esters, and with a liquid, such as water and/or alcohol and/or metal oxide sols, the paste is mixed in a mixing/kneading apparatus and compressed, for example, in an extruder, and the resulting plastic composition is then shaped, advantageously using an extruding press or an extruder. The resulting moulded bodies are usually then dried. It may be advantageous to dry them under atmospheres that promote condensation, such as an ammonia atmosphere.

In general, tempering, or calcining, in the range from 200 to 600° C. is also carried out. Tempering under an inert gas atmosphere, such as nitrogen, hydrogen, noble gases or combinations thereof, at a temperature in the range from 200 to 450° C. is preferably carried out.

It may be advantageous to carry out the above process in the presence of one or more fillers and/or one or more detergents and/or organic viscosity-increasing compounds.

It may also be advantageous to add one or more hardeners, such as alkali silicate solution, to the plastic composition.

In principle there is no limit to the choice of binders. Binders based on the amorphous or crystalline oxides of silicon, titanium, zirconium, aluminium, boron or mixtures thereof, and/or clay minerals such as montmorillonites, kaolins, etc. and/or metallic acid esters and/or crosslinkable polysilanols are preferred. However, there are preferably added as binders metal oxide sols of silicon, aluminium and zirconium or metallic acid esters such as orthosilicic acid ester, tetraalkoxysilanes, alkyl(aryl)-trialkoxysilanes, tetraalkoxy titanates, trialkoxy aluminates, tetraalkoxy zirconates or a mixture of two or more thereof. Such binders are known in the literature in a different context: WO 99/29426-A1 describes inorganic compounds as binders, such as titanium dioxide or titanium dioxide hydrate (JS-A-5 430 000), aluminium oxide hydrate (WO-94/29408-A1), mixtures of silicon and aluminium compounds (WO-94/13584-A1), silicon compounds (EP-A1-0 592 050), clay minerals (JP-A-03 037 156), alkoxysilanes (EP-A1-0 102 544).

The moulded bodies according to the invention preferably contain binder in an amount of up to 95 wt. %, more preferably in the range from 1 to 85 wt. % and especially in the range from 3 to 80 wt. %, in each case based on the total mass of the moulded body, the content of binder being given by the amount of metal oxide formed.

The moulded bodies according to the invention may also be produced by wash-coating of a support material with a suspension consisting of powdered gold- and/or silver-containing organic/inorganic hybrid materials, binders, water and organic emulsifiers, as described in JP 07 155 613, according to which zeolites and silica sol are suspended in water and applied as a wash-coat suspension to a cordierite monolithic support. It may in some cases be advantageous, as described in JP 02 111 438, to use aluminium sol as the binder.

It has been found, however, that some binders cause secondary reactions and hence may reduce the selectivity and the yield in the oxidation reaction. Accordingly, the amount of aluminium-containing binders used should not be too high.

Suitable fillers are all inert materials. Inorganic and/or organic/inorganic metal oxides, such as silicon dioxides, alkyl- or aryl-silicon sesquioxides, titanium oxides, zirconium oxides or mixtures thereof, are preferred. Fibrous fillers, such as glass fibres, cellulose fibres, are also suitable, as are inert components such as graphite, talc, carbon black, coke, etc.

A liquid is used in the production of the moulded bodies to make the composition into a paste. Preference is given to aqueous and/or alcoholic metal oxide sols and/or water and/or alcohols.

In order to prepare a homogeneous suspension of powdered catalytically active noble-metal-containing organic/inorganic hybrid materials for use in shaping processes, especially in the case of hydrophobic hybrid materials or surface-modified materials (silylation), it may be advantageous to add small amounts of detergent. The choice of detergents is not limited, such as sodium dodecylsulfonate, Falterol (Falter Chemie, Krefeld).

The viscosity-increasing inert substances used are advantageously hydrophilic polymers, such as cellulose, methylcellulose, hydroxyethylcellulose, polyacrylates, polysiloxanes, polysilanols, polyvinyl alcohol, polyvinylpyrrolidone, polyisobutene, polytetrahydrofuran, locust bean flour, etc. Such substances primarily promote the formation of a plastic composition during the kneading, shaping and drying step by bridging the primary particles, and they additionally ensure that the moulded body is mechanically stable during shaping and drying. Such substances can be removed from the moulded body again depending on the calcining or tempering conditions.

Further additives which may be added are amines or amine-like compounds, such as tetraalkylammonium compounds or amino alcohols, as well as carbonate-containing substances, such as, for example, calcium carbonate.

In addition to basic components, acid additives, such as carboxylic acids, may also be used.

Basic and/or acid additives (binders) may additionally accelerate the crosslinking reaction of the binder with the organic/inorganic composition according to the invention.

Additives that decompose in gaseous form during the tempering, or calcining, may additionally have an advantageous effect on the porosity of the moulded-body material.

The order in which the components are added to produce the moulded bodies is not critical. It is possible either to add first the binder, then optionally the filler and the viscosity-increasing substance, optionally the additive and finally the mixture containing a liquid such as water and/or alcohol and/or metal oxide sol and/or hardeners such as alkali silicate solutions, or the order in which the binder, the viscosity-increasing substance and the additives are added may be reversed.

The extrudable plastic composition obtained after homogenisation may in principle be processed to moulded bodies in all known kneading and shaping apparatuses (for example described in Ullmanns Enzyklopädie der Technischen Chemie, 4th edition, Vol. 2, p. 295 ff, 1972). Shaping is preferably carried out by means of an extruding press or by extrusion in conventional extruders, for example to form strands having a diameter usually in the range from 1 to 10 mm, especially from 2 to 5 mm.

When the extrusion-moulding or extrusion is complete, the resulting moulded bodies are dried generally in the range from 25 to 150° C. at normal pressure or in vacuo.

It may also be expedient to allow the still moist moulded bodies to age in an atmosphere that promotes condensation, such as ammonia/air mixtures, before they are dried.

Subsequent dip-coating of the moulded bodies in liquids such as metallic acid esters, organically modified metallic acid esters and/or basic or acid liquids may often markedly improve the mechanical stability (e.g. spin-coating method; Oun-Ho Park, Young-Joo Eo, Yoon-Ki Choi and Byeong soo Bae, Journal of Sol-Gel Science and Technology 16, 235-241 (1999)).

Suitable dip-coating solutions are crosslinking agent liquids, such as inorganic and/or organic/inorganic metallic acid esters, which may optionally be in pre-hydrolysed form, and/or alkaline or acid liquids.

The moulded bodies according to the invention may advantageously be activated further by heat treatment in the range from 100 to 1000° C. in various atmospheres such as oxygen, air, nitrogen, hydrogen, carbon monoxide, carbon dioxide. Preference is given to heat activation in the range from 150 to 500° C. in oxygen-containing gases, such as air, oxygen, or oxygen/hydrogen or oxygen/noble gas mixtures or combinations thereof, or under inert gases in the range from 150 to 1000° C., such as nitrogen and/or hydrogen and/or noble gases or combinations thereof. Activation of the moulded bodies is carried out particularly preferably under inert gases at a temperature in the range from 200 to 600° C.

As an alternative to the described moulded-body processes (conversion of the powdered gold- and/or silver-containing organic/inorganic hybrid materials into moulded bodies using inter alia binders, fillers and shaping apparatuses such as extruding presses, extrudates, etc.), it is advantageous to apply the organic/inorganic hybrid materials without the noble metal to inert moulded bodies by impregnation and then apply the noble metal to the impregnated moulded bodies.

The invention relates also to that impregnation process for the production of moulded bodies according to the invention, characterised in that organic/inorganic hybrid material without a noble metal content is applied directly to inert moulded bodies by impregnation and the moulded bodies are subsequently coated with gold and/or silver particles.

Impregnation may be carried out in one or more steps. Advantageously, inert moulded bodies, for example commercial systems based on the oxides of silicon, zirconium, aluminium, clays, etc. (examples are Aerosil or Ultrasil moulded bodies from Degussa, Pural moulded bodies from Condea or clay minerals such as montmorillonites and kaolins), are impregnated in a first step with an organic/inorganic sol containing titanium, then dried and, optionally, tempered.

The subsequent production of the noble metal particles on the supported organic/inorganic hybrid material is not limited to one method. Some examples of methods of generating gold and/or silver particles are mentioned here, such as impregnation in solution, incipient wetness, deposition-precipitation, as described on page 3, line 38 ff of EP-B-0 709 360, colloid processes, sputtering, CVD, PVD. It is also possible to integrate precursor compounds of the noble metals directly into the organic/inorganic sol. After drying and tempering of the supported noble-metal-containing hybrid materials, nano-scale gold and/or silver particles are likewise obtained.

The necessary nano-scale gold and/or silver particles are preferably produced by the method of incipient wetness or impregnation.

The moulded body so coated with gold- and/or silver-containing organic/inorganic hybrid materials is advantageously activated further, before and/or after being coated with the noble metal, by heat treatment in the range from 100 to 1000° C. in various atmospheres such as air, nitrogen, hydrogen, carbon monoxide, carbon dioxide.

Preference is given to heat activation in the range from 150 to 400° C. in oxygen-containing gases, such as air, or oxygen/hydrogen or oxygen/noble gas mixtures or combinations thereof, or under inert gases in the range from 150 to 1000° C., such as nitrogen and/or hydrogen and/or noble gases or combinations thereof. Activation of the moulded bodies impregnated with active components is carried out particularly preferably under inert gases at a temperature in the range from 200 to 600° C. It may, however, also be advantageous to temper, or calcine, the inert support materials for the moulded bodies at temperatures in the range from 200 to 1000° C. and subsequently coat them with titanium-containing organic/inorganic hybrid materials and noble metal.

The catalytic activity and, especially, the catalyst useful life of the moulded bodies according to the invention may frequently be increased by modification of the surface.

Within the scope of the invention, modification is to be understood as meaning especially the application of groups selected from silicon alkyl, silicon aryl, fluorine-containing alkyl and fluorine-containing aryl groups to the surface of the supported composition, the groups being bonded in a covalent or coordinate manner to the functional groups (e.g. OH groups) on the surface. However, any other surface treatment is also expressly included in the scope of the invention.

Modification is preferably carried out using organosilicon and/or fluorine-containing organosilicon or organic compounds, with preference being given to organosilicon compounds.

Suitable organosilicon compounds are all silylating agents known to the person skilled in the art, such as organic silanes, organic silylamines, organic silylamides and derivatives thereof, organic silazanes, organic siloxanes and other organosilicon compounds, which may, of course, also be used in combination. Compounds of silicon and partially fluorinated or perfluorinated organic radicals are also expressly subsumed under organosilicon compounds.

Specific examples of organic silanes are chlorotrimethylsilane, dichlorodimethylsilane, chlorobromodimethylsilane, nitrotrimethylsilane, chlorotrimethylsilane, iododimethylbutylsilane, chlorodimethylphenylsilane, chlorodimethylsilane, dimethyl-n-propylchlorosilane, dimethyliso-propylchlorosilane, tert-butyldimethylchlorosilane, tripropylchlorosilane, dimethyloctylchlorosilane, tributylchlorosilane, trihexylchlorosilane, dimethylethyl-chlorosilane, dimethyloctadecylchlorosilane, n-butyldimethylchlorosilane, bromomethyldimethylchlorosilane, chloromethyldimethylchlorosilane, 3-chloropropyldimethylchlorosilane, dimethoxymethylchlorosilane, methylphenyl-chlorosilane, triethoxychlorosilane, dimethylphenylchlorosilane, methylphenyl-vinylchlorosilane, benzyldimethylchlorosilane, diphenylchlorosilane, diphenylmethylchlorosilane, diphenylvinylchlorosilane, tribenzylchlorosilane and 3-cyanopropyldimethylchlorosilane.

Specific examples of organic silylamines are N-trimethylsilyldiethylamine, pentafluorophenyldimethylsilylamine including N-trimethylsilylimidazoles, N-tert-butyldimethylsilylimidazole, N-dimethylethylsilylimidazole, N-dimethyl-n-propylsilylimidazole, N-dimethylisopropylsilylimidazole, N-trimethylsilyldimethylamine, N-trimethylsilylpyrrole, N-trimethylsilylpyrrolidine, N-trimethylsilylpiperidine and 1-cyanoethyl(diethylamino)dimethylsilane.

Specific examples of organic silylamides and derivatives thereof are N,O-bistrimethylsilylacetamide, N,O-bistrimethylsilyltrifluoroacetamide, N-trimethylsilylacetamide, N-methyl-N-trimethylsilylacetamide, N-methyl-N-trimethylsilyltrifluoroacetamide, N-methyl-N-trimethylsilylheptafluorobutyramide, N-(tert-butyldimethylsilyl)-N-trifluoroacetamide and N,O-bis(diethylhydrosilyl)trifluoroacetamide.

Specific examples of organic silazanes are hexamethyldisilazane, heptamethyldisilazane, 1,1,3,3-tetramethyldisilazane, 1,3-bis(chloromethyl)-tetramethyldisilazane, 1,3-divinyl-1,1,3,3-tetramethyldisilazane and 1,3-diphenyltetramethyldisilazane.

Examples of other organosilicon compounds are N-methoxy-N,O-bistrimethylsilyltrifluoroacetamide, N-methoxy-N,O-bistrimethylsilylcarbamate, N,O-bistrimethylsilylsulfamate, trimethylsilyltrifluoromethanesulfonate and N,N′-bistrimethylsilylurea.

Preferred silylating reagents are hexamethyldisilazane, hexamethyldisiloxane, N-methyl-N-(trimethylsilyl)-2,2,2-trifluoroacetamide (MSTFA) and trimethylchlorosilane.

The gold- and/or silver-containing organic/inorganic hybrid materials (moulded bodies or powders) according to the invention may additionally be treated, prior to any surface modification, with basic solutions, such as aqueous-alcoholic ammonia solution. In the case of the preferred gold- and/or silver-containing organic/inorganic hybrid materials having silane units, the process steps base treatment, drying, optional tempering, modification, tempering lead to often significantly longer catalyst useful lives.

In processes for the catalytic oxidation of unsaturated and saturated hydrocarbons, the optionally heat-activated (tempered) moulded bodies according to the invention frequently exhibit a significantly higher catalytic activity and a useful life lengthened by a factor of from 2 to 3 in comparison with hitherto known powder catalysts. Accordingly, the invention relates also to the use of the moulded bodies according to the invention in the oxidation of hydrocarbons.

The term hydrocarbon is understood as meaning unsaturated or saturated hydrocarbons, such as olefins or alkanes, which may also contain hetero atoms, such as N, O, P, S or halogens. The organic component to be oxidised may be acyclic, monocyclic, bicyclic or polycyclic and may be monoolefinic, diolefinic or polyolefmic. In the case of organic components having two or more double bonds, the double bonds may be conjugate or non-conjugate. There are preferably oxidised hydrocarbons from which there are formed oxidation products whose partial pressure is low enough to remove the product continuously from the catalyst. Preference is given to unsaturated and saturated hydrocarbons having from 2 to 20, preferably from 2 to 10, carbon atoms, especially ethene, ethane, propene, propane, isobutane, isobutylene, 1-butene, 2-butene, cis-2-butene, trans-2-butene, 1,3-butadiene, pentene, pentane, 1-hexene, 1-hexane, hexadiene, cyclohexene, benzene.

The moulded bodies may be used for oxidation reactions in any desired physical form, for example coarse powders, spherical particles, pellets, extrudates, granules, agglomerates by spray drying, etc.

A preferred use is the gas-phase reaction of hydrocarbons with oxygen/hydrogen mixtures in the presence of the moulded bodies. In that reaction there are selectively obtained epoxides from olefins, ketones from saturated secondary hydrocarbons and alcohols from saturated tertiary hydrocarbons. The catalyst useful lives in that process are several weeks, months or longer, depending on the starting material used.

The molar amount of the hydrocarbon used, based on the total number of moles of hydrocarbon, oxygen, hydrogen and diluting gas, and the relative molar ratio of the components may be varied within wide limits. There is preferably used an excess of hydrocarbon, based on the oxygen used (on a molar basis). The hydrocarbon content is typically greater than 1 mol % and less than 90 mol %. Hydrocarbon contents in the range from 5 to 80 mol %, particularly preferably in the range from 10 to 80 mol %, are preferably used.

The oxygen may be used in a wide variety of forms, such as molecular oxygen, air and nitrogen oxide. Molecular oxygen is preferred.

The molar amount of oxygen, based on the total number of moles of hydrocarbon, oxygen, hydrogen and diluting gas, may be varied within wide limits. The molar amount of oxygen used is preferably less than that of the hydrocarbon. Oxygen is preferably used in an amount in the range from 1 to 30 mol %, particularly preferably from 5 to 25 mol %.

In the absence of hydrogen, the moulded bodies according to the invention exhibit only very low activity and selectivity. At temperatures up to 180° C., the productivity is generally low in the absence of hydrogen; at temperatures above 200° C., relatively large amounts of carbon dioxide are formed in addition to partial oxidation products.

Any known hydrogen source may be used, such as pure hydrogen, synthesis gas or hydrogen from the dehydrogenation of hydrocarbons and alcohols. In another embodiment of the invention, the hydrogen may also be produced in situ in a reactor located upstream, for example by the dehydrogenation of propane or isobutane or alcohols, such as, for example, methanol or isobutanol. The hydrogen may also be introduced into the reaction system in the form of a complex-bonded species, for example catalyst/hydrogen complex.

The molar amount of hydrogen, based on the total number of moles of hydrocarbon, oxygen, hydrogen and diluting gas, may be varied within wide limits. Typical hydrogen contents are greater than 0.1 mol %, preferably in the range from 4 to 80 mol %, particularly preferably in the range from 5 to 70 mol %.

In addition to the above-described starting-material gases that are necessary, there may optionally also be used a diluting gas, such as nitrogen, helium, argon, methane, carbon dioxide, carbon monoxide or similar, predominantly inert gases. Mixtures of the described inert components may also be used. The addition of inert components is advantageous for dissipating the heat released in the exothermic oxidation reaction, and from the point of view of safety.

If the process according to the invention is carried out in the gas phase, gaseous diluting components, such as, for example, nitrogen, helium, argon, methane and, optionally, water vapour and carbon dioxide, are preferably used. Although water vapour and carbon dioxide are not completely inert, they have a positive effect at very low concentrations (<2 vol. %).

If the invention is carried out in the liquid phase, an inert liquid that is stable to oxidation and thermally stable is advantageously chosen (e.g. alcohols, polyalcohols, polyethers, halogenated hydrocarbons, silicone oils). The moulded bodies according to the invention are also suitable for the oxidation of hydrocarbons in the liquid phase. Both in the presence of organic hydroperoxides (R-OOH), olefins, for example, are converted in the liquid phase into epoxides in a highly selective manner on the described catalysts, and in the presence of hydrogen peroxide or in the presence of oxygen and hydrogen, olefins are converted in the liquid phase into epoxides in a highly selective manner on the described catalysts.

It has been found that the above-described selective oxidation reaction exhibits a high degree of structural sensitivity of the catalyst. In the presence of nano-disperse gold and/or silver particles in the moulded body, an advantageous increase in productivity to the selective oxidation product was observed.

The compositions according to the invention can be prepared on a commercial scale without difficulty and inexpensively in terms of process technology.

The catalysts, which after several months have become slightly inactive, can frequently be partly regenerated again both thermally and by washing with suitable solvents, such as, for example, alcohols, water, or with hot water vapour or dilute hydrogen peroxide solutions (e.g. from 3 to 10% H₂O₂/methanol solution).

The characteristic properties of the present invention are illustrated in the Examples which follow by means of catalyst preparations and catalytic test reactions.

It will be understood that the invention is not limited to the Examples which follow.

### EXAMPLES

Specification for the testing of the moulded bodies (test specification)

A metal tube reactor having an inside diameter of 10 mm and a length of 20 cm was used; the temperature of the reactor was controlled by means of an oil thermostat. The reactor was supplied with starting-material gases by means of a set of four mass-flow regulators (hydrocarbon, oxygen, hydrogen, nitrogen). For the reaction, x g of moulded bodies (containing 500 mg of powdered catalytically active organic/inorganic hybrid materials) were placed in the reactor at 160° C. and normal pressure. The starting-material gases were fed into the reactor from above. The standard catalyst load was 3 litres of gas/(g of composition*h). The “standard hydrocarbon” chosen was, for example, propene.

For carrying out the oxidation reactions, a stream of gas, always referred to hereinbelow as the standard gas composition, was chosen:

H₂/O₂/C₃H₆:60/10/30 vol. %.

The reaction gases were analysed quantitatively by means of gas chromatography. Separation of the individual reaction products by gas chromatography was carried out by a combined FID/TCD method, in which three capillary columns are passed through:

FID: HP-Innowax, 0.32 mm inside diameter, 60 m long, 0.25 μm layer thickness.

TCD: Series connection of

HP-Plot Q, 0.32 mm inside diameter, 30 m long, 20 μm layer thickness

HP-Plot molecular sieve 5 A, 0.32 mm inside diameter, 30 m long, 12 μm layer thickness.

### Example 1

This example describes the preparation of a powdered catalytically active organic/inorganic hybrid material consisting of a silicon- and titanium-containing, organic/inorganic hybrid material having free silane units, which has been coated with gold particles (0.04 wt. %) by means of incipient wetness.

1.9 g of a 0.1 n solution of p-toluenesulfonic acid in water were added to 10.1 g of methyltrimethoxysilane (74.1 mmol) and 15 g of ethanol (analytically pure), and the mixture was stirred for 2 hours. 5.6 g of triethoxysilane (34.1 mmol) were then added, and the mixture was stirred for a further 20 minutes; then 1.46 g of tetrabutoxytitanium (4.3 mmol) were added, the mixture was again stirred for 60 minutes, a mixture of 1.23 g of a 0.1 n solution of p-toluenesulfonic acid in water was added, and the mixture was finally allowed to stand. The batch reaches the gel point after approximately 7 minutes. After an ageing time of 12 hours, the gel was comminuted, washed twice with 50 ml of hexane each time, and dried for 2 hours at room temperature and 8 hours at 120° C. in air.

2.69 g of dried sol-gel material were impregnated, with stirring, with 1.07 g of a 0.1% solution of HAuCl₄×H₂O in methanol (incipient wetness), dried at room temperature in a stream of air, and then tempered for 8 hours at 120° C. in air and then for 3 hours at 400° C. under a nitrogen atmosphere. The catalytically active organic/inorganic hybrid material so prepared contains 0.04 wt. % gold.

In a variation of the test specification, 500 mg of powdered catalytically active organic/inorganic hybrid material were used as the catalyst instead of moulded bodies. A constant PO selectivity of 95% was achieved. The catalyst productivity of 80 mg of PO/(g of organic/inorganic hybrid material having a content of 0.04 wt. % Au×h) which was achieved after 8 hours levelled off after 10 days at 70 mg of PO/(g of organic/inorganic hybrid material having a content of 0.04 wt. % Au×h).

### Example 2

Preparation of a Moulded Body Having a Content of 56 wt. % Noble-Metal-Containing Organic/Inorganic Hybrid Material

1.7 g of organic/inorganic hybrid material, synthesised according to Example 1, were mixed intensively for 2 hours with 2.6 g of silicon dioxide sol (Levasil, Bayer, 300 m²/g, 30 wt. % SiO₂ in water) and 0.37 g of SiO₂ powder (Ultrasil VN3, Degussa). 0.6 g of sodium silicate solution (Aldrich) was added to the resulting plastic composition, and the mixture was homogenised intensively for 5 minutes and then shaped into 2 mm strands in an extruding press. The strands so produced were dried first for 8 hours at room temperature and then for 5 hours at 120° C. and then tempered for 4 hours under a nitrogen atmosphere at 400° C. The mechanically stable moulded body having high lateral pressure resistance contains 56 wt. % catalytically active organic/inorganic hybrid material.

The tempered moulded bodies were processed to 2×2 mm strands and used as catalyst in the gas-phase epoxidation of propene with molecular oxygen in the presence of hydrogen.

In accordance with the test specification, 890 mg of moulded bodies (which contains 500 mg of organic/inorganic hybrid material having a content of 0.04 wt. % Au) were used as catalyst. A constant PO selectivity of 95% was achieved. The catalyst productivity of 80 mg of PO/(g of organic/inorganic hybrid material having a content of 0.04 wt. % Au×h) which was achieved after 9 hours levelled off after 10 days at 75 mg of PO/(g of organic/inorganic hybrid material having a content of 0.04 wt. % Au×h).

### Example 3

Preparation of a Moulded Body Having a Content of 56 wt. % Noble-Metal-Containing Organic/Inorganic Hybrid Material

Preparation of a moulded body analogously to Example 2, but Aerosil 200 (Degussa, pyrogenic SiO₂) was used as the SiO₂ powder instead of Ultrasil VN 3 (Degussa, precipitated silica gel).

In accordance with the test specification, 890 mg of moulded bodies (which contains 500 mg of organic/inorganic hybrid material having a content of 0.04 wt. % Au) were used as catalyst. A constant PO selectivity of 95% was achieved. The catalyst productivity of 80 mg of PO/(g of organic/inorganic hybrid material having a content of 0.04 wt. % Au×h) which was achieved after 7 hours levelled off after 10 days at 74 mg of PO/(g of organic/inorganic hybrid material having a content of 0.04 wt. % Au×h).

### Comparison Example 1

Preparation of a Powdered, Purely Inorganic Catalyst Material According to EP-A1-0 827 771

This example describes the preparation of a powdered hydrophilic, purely inorganic catalyst support analogously to EP-A1-0 827 771, consisting of the oxides of silicon and titanium, which is coated with gold particles by deposition-precipitation. The titanium-containing inorganic catalyst support is obtained by impregnating pyrogenic, purely inorganic silica with titanyl acetylacetonate.

30 g of Aerosil 200 (pyrogenic silicon dioxide, Degussa, 200 m²/g) are suspended in 250 ml of dry methanol; 0.98 g of titanyl acetylacetonate (3.9 mmol, Merck) is added, and the mixture is stirred for 2 hours at room temperature. The suspension is concentrated to dryness in a rotary evaporator, and the solid is then dried at 130° C. and calcined for 3 hours at 600° C. in a stream of air.

0.16 g of tetrachloroauric acid (0.4 mmol, Merck) is dissolved in 500 ml of distilled water, adjusted to pH 8.8 with a 2 n sodium hydroxide solution and warmed to 70° C.; 10 g of the above titanium-containing silica are added, and stirring is carried out for one hour. The solid is filtered off, washed with 30 ml of distilled water, dried for 10 hours at 120° C. and calcined for 3 hours at 400° C. in air. According to ICP analysis, the catalyst contains 0.45 wt. % gold.

In a variation of the test specification, 500 mg of powdered, purely inorganic catalyst material were used as the catalyst instead of moulded bodies. A constant PO selectivity of 95% was achieved. The catalyst reached a catalyst productivity of 6 mg of PO/(g of purely inorganic catalyst material×h) after 20 minutes, a catalyst productivity of 4 mg of PO/(g of purely inorganic catalyst material×h) after 100 minutes, a catalyst productivity of 2 mg of PO/(g of purely inorganic catalyst material×h) after 4 hours and a catalyst productivity of 2 mg of PO/(g of purely inorganic catalyst material×h) after 50 hours. The deactivation of the catalyst increased further as the time increased.

### Example 4

Preparation of a Moulded Body Containing 56 wt. % Purely Inorganic Catalyst Material According to Comparison Example 1

1.7 g of purely inorganic catalyst material, synthesised according to Comparison Example 1, were mixed intensively for 2 hours with 2.6 g of silicon dioxide sol (Levasil, Bayer, 300 m²/g, 30 wt. % SiO₂ in water) and 0.37 g of SiO₂ powder (Ultrasil VN3, Degussa). 0.6 g of sodium silicate solution (Aldrich) was added to the resulting plastic composition, and the mixture was homogenised intensively for 5 minutes and then shaped into 2 mm strands in an extruding press. The strands so produced were dried first for 8 hours at room temperature and then for 5 hours at 120° C. and then tempered for 4 hours under a nitrogen atmosphere at 400° C. The tempered moulded body was processed to 2×2 mm strands and used as catalyst in the gas-phase epoxidation of propene with molecular oxygen in the presence of hydrogen.

In a test in accordance with the test specification, with PO selectivities of 93%, a catalyst productivity of 7 mg of PO/(g of purely inorganic catalyst material×h) was reached after 20 minutes, a catalyst productivity of 5 mg of PO/(g of purely inorganic catalyst material×h) was reached after 100 minutes, a catalyst productivity of 3 mg of PO/(g of purely inorganic catalyst material×h) was reached after 4 hours and a catalyst productivity of 2 mg of PO/(g of purely inorganic catalyst material×h) was reached after 50 hours. The deactivation of the catalyst increased further as the time increased.

### Comparison Example 2

Preparation of a Powdered Purely Inorganic Catalyst Material According to WO-98/00413-A1

This example describes the preparation of a powdered, purely inorganic crystalline titanium silicalite catalyst support (TS 1), consisting of the framework oxides of silicon and titanium, which was coated with gold analogously to WO-98/00413-A1. The TS 1 catalyst support from Leuna was obtained by hydrothermal synthesis. The inorganic Si and Ti framework silicate has an MFI structure (XRD) and it was possible to demonstrate, by means of Raman spectroscopy, that the material contains no crystalline titanium dioxide phases.

10.04 g of TS 1 (Leuna) are suspended analogously to WO 98/00413 in an aqueous tetrachloroauric acid solution (0.483-g HAuCl₄*3 H₂O in 50 ml of water), and the pH value is adjusted to pH 7.8 with 2 n Na₂CO₃ solution; 1.97 g of magnesium nitrate (Mg(NO₃)₂*6H₂O) are added, and the pH value is again adjusted to pH 7.8 with 2 n Na₂CO₃ solution; the mixture is stirred for 8 hours, and the solid is filtered off, washed three times with 150 ml of H₂O each time, dried for 2 hours at 100° C., heated to 400° C. in the course of 8 hours, and maintained at 400° C. for 5 hours. The purely inorganic catalyst contains 0.95 wt. % gold (ICP).

In a test in accordance with the test specification, with PO selectivities of 93%, a catalyst productivity of 8 mg of PO/(g of purely inorganic catalyst material×h) was reached after 20 minutes, a catalyst productivity of 6 mg of PO/(g of purely inorganic catalyst material×h) was reached after 100 minutes, a catalyst productivity of 5 mg of PO/(g of purely inorganic catalyst material×h) was reached after 4 hours and a catalyst productivity of 4 mg of PO/(g of purely inorganic catalyst material×h) was reached after 50 hours. The deactivation of the catalyst increased further as the time increased.

### Example 5

Preparation of a Moulded Body Containing 56 wt. % of a Purely Inorganic Catalyst Material According to Comparison Example 2

1.7 g of purely inorganic catalyst material, synthesised according to Comparison Example 2, were mixed intensively for 2 hours with 2.6 g of silicon dioxide sol (Levasil, Bayer, 300 m²/g, 30 wt. % SiO₂ in water) and 0.37 g of SiO₂ powder (Ultrasil VN3, Degussa). 0.6 g of sodium silicate solution (Aldrich) was added to the resulting plastic composition, and the mixture was homogenised intensively for 5 minutes and then shaped into 2 mm strands in an extruding press. The strands so produced were dried first for 8 hours at room temperature and then for 5 hours at 120° C. and then tempered for 4 hours under a nitrogen atmosphere at 400° C. The tempered moulded body was processed to 2×2 mm strands and used as catalyst in the gas-phase epoxidation of propene with molecular oxygen in the presence of hydrogen.

In a test in accordance with the test specification, with PO selectivities of 93%, a catalyst productivity of 9 mg of PO/(g of purely inorganic catalyst material×h) was reached after 20 minutes, a catalyst productivity of 7 mg of PO/(g of purely inorganic catalyst material×h) was reached after 100 minutes, a catalyst productivity of 6 mg of PO/(g of purely inorganic catalyst material×h) was reached after 4 hours and a catalyst productivity of 5 mg of PO/(g of purely inorganic catalyst material×h) was reached after 50 hours. The deactivation of the catalyst increased further as the time increased.

### Example 6

Preparation of a Moulded Body Containing Organic/Inorganic Hybrid Material

2 g of organic/inorganic hybrid material, synthesised according to Example 1, were mixed intensively for 2 hours with 1.3 g of tetramethoxysilane. 0.24 g of methylcellulose was then added, and the mixture was homogenised to a plastic composition. The resulting plastic composition was compressed further for one hour in a kneader and then shaped into 2 mm strands in an extruding press. The strands so produced were dried first for 8 hours at room temperature and then for 5 hours at 120° C. and then tempered for 4 hours at 400° C. under a nitrogen atmosphere.

The tempered moulded body was processed to 2×2 mm strands and used as catalyst in the gas-phase epoxidation of propene with molecular oxygen in the presence of hydrogen.

In accordance with the test specification, 714 mg of moulded bodies (which contains 500 mg of organic/inorganic hybrid material having a content of 0.04 wt. % Au) were used as catalyst. A constant PO selectivity of 95% was achieved. The catalyst productivity of 60 mg of PO/(g of organic/inorganic hybrid material having a content 5 of 0.04 wt. % Au×h) which was achieved after 11 hours levelled off after 10 days at 50 mg of PO/(g of organic/inorganic hybrid material having a content of 0.04 wt. % Au×h).

### Example 7

Preparation of a Moulded Body Containing Organic/Inorganic Hybrid Material

Preparation of a moulded body analogously to Example 6, but the still moist moulded body was dipped in 0.1 n sodium silicate solution for 10 seconds and then dried, tempered and used as catalyst analogously to Example 6.

The mechanically stable moulded body having high lateral pressure resistance contains 70 wt. % catalytically active organic/inorganic hybrid material according to Example 1.

In accordance with the test specification, 714 mg of moulded bodies (which contains 500 mg of organic/inorganic hybrid material having a content of 0.04 wt. % Au) were used as catalyst. A constant PO selectivity of 95% was achieved. The catalyst productivity of 75 mg of PO/(g of organic/inorganic hybrid material having a content of 0.04 wt. % Au×h) which was achieved after 8 hours levelled off after 10 days at 70 mg of PO/(g of organic/inorganic hybrid material having a content of 0.04 wt. % Au×h).

### Example 8

Fixing of the Catalytically Active Species to Commercial SiO₂ Moulded Bodies

This example describes the fixing of the catalytically active species to commercial Aerosil 200 moulded bodies (Degussa; 3 mm spheres) having high mechanical stability. The catalytically active species consist of a silicon- and titanium-containing, organic/inorganic hybrid material having free silane units, which has been coated with gold particles by means of incipient wetness.

1.0 g of a 0.1 n solution of p-toluenesulfonic acid in water was added to 3.1 g of methyltrimethoxysilane (22.8 mmol), 5.6 g of triethoxysilane (34.1 mmol) and 5 g of ethanol (analytically pure), and the mixture was stirred for 20 minutes. 1.08 g of tetrabutoxytitanium (3.4 mmol) were then added, and the mixture was stirred for a further 60 minutes.

The Aerosil 200 moulded bodies (3 mm spheres) were impregnated with the resulting solution by means of incipient wetness. The impregnated, but macroscopically dry moulded bodies are dried for 8 hours at room temperature in air, and then tempered for 4 hours at 120° C. in air and for one hour at 400° C. under an inert gas atmosphere (nitrogen).

1.4 g of tempered impregnated moulded bodies were suspended in a methanol/2% aqueous ammonia solution (80:20) and allowed to stand for 5 hours at room temperature; the supernatant liquor was decanted off, and the solid was dried for 5 hours at 120° C., added to a mixture of 20 ml of hexane and 0.4 g of hexamethyldisilazane, and stirred for 4 hours at 50° C.; the supernatant liquor was decanted off, and the solid was dried for 4 hours at 120° C. and tempered for 2 hours at 300° C.

1.4 g of tempered and modified impregnated moulded bodies were impregnated with 0.5 g of a 0.1% solution of HAuCl₄×H₂O in methanol (incipient wetness), dried at room temperature in air, and then tempered for 8 hours at 120° C. in air and for 3 hours at 400° C. under an inert gas atmosphere (nitrogen). The catalytically active moulded bodies so produced are used as catalysts in the direct oxidation of propene with oxygen and hydrogen.

In a test in accordance with the test specification, a constant PO selectivity of 95% was achieved. The catalyst productivity of 50 mg of PO/(g of catalytically active moulded bodies×h) which was achieved after 5 hours levelled off after 10 days at 45 mg of PO/(g of catalytically active moulded bodies×h).

### Example 9

Trans-2-butene is used as the unsaturated hydrocarbon instead of propene. A moulded-body catalyst analogous to Example 2 is used for the partial oxidation of trans-2-butene.

In accordance with the test specification, 890 mg of moulded bodies according to Example 2 (which contains 500 mg of organic/inorganic hybrid material having a content of 0.04 wt. % Au according to Example 1) were used as catalyst. A constant butene oxide selectivity of 95% was achieved. The catalyst productivity of 41 mg of butylene oxide/(g of organic/inorganic hybrid material having a content of 0.04 wt. % Au×h) which was achieved after 7 hours levelled off after 10 days at 37 mg of butylene oxide/(g of organic/inorganic hybrid material having a content of 0.04 wt. % Au×h).

### Example 10

Cyclohexene is chosen as the unsaturated hydrocarbon instead of propene. A catalyst analogous to Example 1 is used for the partial oxidation of cyclohexene. Cyclohexene is introduced into the gas phase by means of a vaporizer.

In accordance with the test specification, 890 mg of moulded bodies according to Example 2 (which contains 500 mg of organic/inorganic hybrid material having a content of 0.04 wt. % Au according to Example 1) were used as catalyst. A constant hexene oxide selectivity of 95% was achieved. The catalyst productivity of 35 mg of hexene oxide/(g of organic/inorganic hybrid material having a content of 0.04 wt. % Au×h) which was achieved after 7 hours levelled off after 10 days at 32 mg of hexene oxide/(g of organic/inorganic hybrid material having a content of 0.04 wt. % Au×h).

### Example 11

1,3-Butadiene is chosen as the unsaturated hydrocarbon instead of propene. A moulded-body catalyst analogous to Example 2 is used for the partial oxidation of 1,3-butadiene.

In accordance with the test specification, 890 mg of moulded bodies according to Example 2 (which contains 500 mg of organic/inorganic hybrid material having a content of 0.04 wt. % Au according to Example 1) were used as catalyst. A constant butene monooxide selectivity of 85% was achieved. The catalyst productivity of 17 mg of butene monooxide/(g of organic/inorganic hybrid material having a content of 0.04 wt. % Au×h) which was achieved after 7 hours levelled off after 10 days at 10 mg of butene monooxide/(g of organic/inorganic hybrid material having a content of 0.04 wt. % Au×h).

### Example 12

Propane is used as the saturated hydrocarbon instead of propene. A moulded-body catalyst analogous to Example 2 is used for the partial oxidation of propane.

In accordance with the test specification, 890 mg of moulded bodies according to Example 2 (which contains 500 mg of organic/inorganic hybrid material having a content of 0.04 wt. % Au according to Example 1) were used as catalyst. A constant acetone selectivity of 75% was achieved. The catalyst productivity of 15 mg of acetone/(g of organic/inorganic hybrid material having a content of 0.04 wt. % Au×h) which was achieved after 6 hours levelled off after 10 days at 10 mg of acetone/(g of organic/inorganic hybrid material having a content of 0.04 wt. % Au×h).

1. Moulded bodies containing organic/inorganic hybrid materials and also gold and/or silver particles.

2. Moulded bodies according to claim 1, characterised in that the organic/inorganic hybrid materials contain terminal and/or bridging organic groups.

3. Moulded bodies according to claim 1 and/or 2, characterised in that the organic/inorganic hybrid materials contain oxides of silicon and titanium.

4. Moulded bodies according to one or more of claims 1 to 3, characterised in that they have a content of silicon dioxide as support matrix of from 1 to 98 wt. %.

5. Moulded bodies according to one or more of claims 1 to 4, characterised in that they contain further foreign oxides, so-called promoters.

6. Moulded bodies according to one or more of claims 1 to 5, characterised in that the active catalysts contained in the shaped support contain gold in an amount in the range from 0.001 to 4 wt. %.

7. Moulded bodies according to one or more of claims 1 to 6, characterised in that the gold particles have a diameter <10 nm.

8. Moulded bodies according to one or more of claims 1 to 7, characterised in that the organic/inorganic hybrid materials additionally contain silane units.

9. Moulded bodies according to one or more of claims 1 to 8, characterised in that the organic/inorganic hybrid materials are treated with aqueous bases in the liquid or gas phase before or after being coated with noble metal.

10. Moulded bodies according to one or more of claims 1 to 9, characterised in that their surface has been modified with silicon alkyl and/or silicon aryl compounds.

11. Process for the production of moulded bodies according to claim 1, characterised in that a metal oxide sol and/or metallic oxide ester is added to gold- and/or silver-containing organic/inorganic hybrid material and, optionally after addition of a binder, of a filler and of an alkali and/or alkaline earth silicate, after mixing and compressing, the mixture is converted into moulded bodies using a shaping tool.

12. Process according to claim 11, characterised in that the metal oxide sol is selected from the group consisting of silicon dioxide sols, aluminium oxide sols, zirconium oxide sols and titanium oxide sols, in each case in aqueous or organic solvents, and a mixture of two or more metal oxide sols.

13. Process according to claim 12, characterised in that the metallic acid ester is selected from the group consisting of orthosilicic acid esters, tetraalkoxysilanes, alkyl(aryl)trialkoxysilanes, tetraalkoxy titanates, trialkoxy aluminate, tetraalkoxy zirconate and a mixture of two or more thereof.

14. Process according to any one of claims 11 to 13, characterised in that the process is carried out in the presence of one or more organic hydrophilic polymers.

15. Process according to any one of claims 11 to 14, characterised in that the shaping tool is an extruding press or an extruder.

16. Process for the preparation of moulded bodies according to claim 1, characterised in that the organic/inorganic hybrid material without a content of noble metal is applied directly to inert moulded bodies by impregnation, and the moulded body is subsequently coated with gold and/or silver particles.

17. Process according to any one of claims 11 to 16, characterised in that the moulded bodies are tempered in an intermediate or final step at temperatures in the range from 100 to 1000° C.

18. Process according to claim 17, characterised in that the tempering is carried out at temperatures in the range from 200 to 600° C. under inert gas.

19. Use of the moulded bodies according to one or more of claims 1 to 10 as a catalyst.

20. Process for the selective and partial oxidation of hydrocarbons in the presence of molecular oxygen and a reducing agent, characterised in that a moulded body according to one or more of claims 1 to 10 is used as catalyst.

21. Process according to claim 20, characterised in that propene is oxidised to propene oxide.
